(19) United States
(12) Patent Application Publication
(10) Pub. No.: US 2008/0250231 A1
(43) Pub. Date: Oct. 9, 2008

(54) PROGRAM CODE CONVERSION APPARATUS, PROGRAM CODE CONVERSION METHOD AND RECORDING MEDIUM

(75) Inventors: Hiroki TAGAWA, Kanagawa (JP); Tohru FURUYAMA, Kanagawa (JP); Nobu MATSUMOTO, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/059,160

(22) Filed: Mar. 31, 2008

(30) Foreign Application Priority Data
Apr. 3, 2007 (JP) 2007-097845
Dec. 25, 2007 (JP) 2007-333098

(51) Int. Cl. G06F 9/44; G06F 9/30

(52) U.S. Cl. 712/220; 717/106; 712/E09.016

(57) ABSTRACT

A program conversion apparatus includes: a code analyzing section configured to analyze an A binary code executable in an A processor in order to convert the A binary code into a program code for a B processor; a instruction function extracting section configured to extract a predetermined instruction function for the B processor which corresponds to a predetermined instruction for the A processor obtained by the analysis performed by the code analyzing section; and a translator section configured to generate a source code for the B processor from the A binary code, by rewriting the predetermined instruction for the A processor to the predetermined instruction function extracted by the instruction function extracting section.

### CROSS-REFERENCE TO RELATED APPLICATION

This application is based upon and claims the benefit of priority from the prior Japanese Patent Applications No. 2007-097845 filed on Apr. 3, 2007 and No. 2007-333098 filed on Dec. 25, 2007; the entire contents of which are incorporated herein by reference.

### BACKGROUND OF THE INVENTION

1. Field of the Invention

The present invention relates to a program code conversion apparatus, a program code conversion method, and a recording medium, and more particularly to a program code conversion apparatus, a program code conversion method, and a recording medium, which convert a first binary code executable in a first processor to a program code for a second processor.

2. Description of the Related Art

Conventionally, a program executable in a processor has been converted so as to be also executable in the other processors. For example, when there are two mutually different processors of X and Y, there are generally the following two methods for obtaining a binary code for the processor Y from a binary code for the processor X.

The first method is a method in which the binary code for the processor X is directly converted to the binary code for the processor Y by using a translator program.

In this method, the converted code is also a binary code, and hence the readability of the converted binary code is low. Thus, it has been difficult for a user who is a programmer to perform a manual debugging of the converted binary code, and to make the converted binary code correspond to a new specification change or subjected to performance tuning. Further, when the instruction system for the processor X is different from the instruction system for the processor Y, there may be a case where the instruction code for the processor X cannot be replaced with the instruction code for the processor Y in one-to-one relation.

The second method is, as disclosed in Japanese Patent Laid-Open No. 2004-252807, a method in which the binary code for the processor X is reversely compiled so as to be once converted into a so-called high level language code, and the binary code for processor Y is obtained by compiling the high level language code with a compiler for the processor Y.

However, the problem of the first method is solved by this method, but there is a following problem.

The problem is that when the high level language code independent from a processor is generated by the reverse compilation, the optimization originally performed in the binary code for the processor X is not guaranteed in the binary code for the processor Y. For example, the problem is that in a case where a code piece manually devised for optimization by the assembly code is included in the binary code, such ingenuity or wisdom in the code piece is not reflected in the high level language code obtained by the reverse compilation. That is, even when an instruction function, as an example of the code piece as the ingenuity on the program, is included in the binary code for the processor X, the code piece is not included in the high level language code obtained by reversely compiling the binary code. As a result, the optimization equivalent to that in the binary code for the processor X is not performed in the binary code for the processor Y which is generated by the compiler for the processor Y from the high level language code.

### SUMMARY OF THE INVENTION

According to an aspect of the present invention, it is possible to provide a program code conversion apparatus which converts a first binary code executable in a first processor, into a program code for a second processor, and which includes: a code analyzing section configured to analyze the first binary code; a instruction function extracting section configured to extract predetermined one or more instruction functions for the second processor which correspond to predetermined one or more instructions for the first processor obtained by the analysis performed by the code analyzing section; and a translator section configured to generate a source code for the second processor as a program code for the second processor from the first binary code, by rewriting the predetermined one or more predetermined instructions for the first processor to the predetermined one or more instruction functions extracted by the instruction function extracting section.

### BRIEF DESCRIPTION OF THE DRAWINGS

FIG. 1 is a figure showing a configuration of a program conversion apparatus according to an embodiment of the present invention;

FIG. 2 is a figure for explaining an example of a flow of program conversion processing according to the embodiment of the present invention;

FIG. 3 is a flow chart showing an example of a processing flow of a conversion processing program according to the embodiment of the present invention;

FIG. 4 is a flow chart showing an example of a processing flow of the conversion processing program according to the embodiment of the present invention;

FIG. 5 is a figure showing an exemplary configuration of a conversion table according to the embodiment of the present invention; and

FIG. 6 is a figure showing an example of a debug screen according to the embodiment of the present invention.

### DETAILED DESCRIPTION OF THE PREFERRED EMBODIMENTS

In the following, an embodiment according to the present invention will be described with reference to the accompanying drawings.

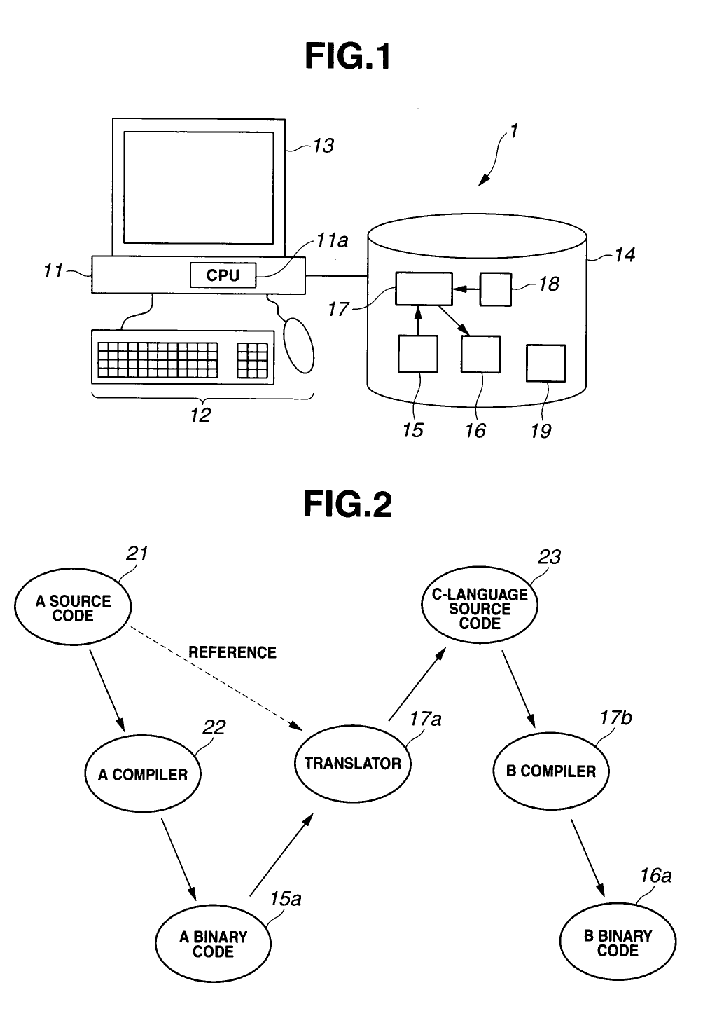

First, a configuration of a program conversion apparatus according to the present embodiment will be described with reference to FIG. 1. FIG. 1 is a figure showing a configuration of a program code conversion apparatus according to the present embodiment.

A program code conversion apparatus (hereinafter referred to as a program conversion apparatus) 1 is a computer such as a personal computer (hereinafter referred to as a PC) configured by including: a computer main body 11 which has a central processing unit (hereinafter referred to as CPU) 11a, a ROM, a RAM, and the like; an input device 12, such as a keyboard and a mouse; a display device 13 having a screen; and a storage device 14 which stores a program to be converted (conversion source program), a converted program (conversion destination program or a program after conversion), and the like. The storage device 14 stores a binary program (hereinafter referred to as a binary code) 15 which is a conversion source object code, a converted binary code 16, a program conversion processing program 17 as will be described below, and a conversion table 18 as will be described below. Further, the storage device 14 stores a debugger 19 which is a debug program. When performing the debugging, the CPU 11a is able to read and execute the debugger 19.

Note that the program conversion apparatus 1 is not limited to the computer configured as described above, and may be an apparatus such as a client-server system connected via a network.

By utilizing the program conversion apparatus 1, a user who performs program conversion is able to make the conversion source binary code 15 subjected to program conversion processing as will be described below, and to obtain the converted binary code 16. By utilizing a man-machine interface (hereinafter referred to as an MMI) which includes the input device 12 and the display device 13, the user specifies the conversion source binary code 15 stored in the storage device 14, and specifies a storage area of the storage device 14, in which the converted binary code 16 is stored.

Further, by utilizing the MMI, the user is able to specify the conversion processing program 17 which performs the program conversion processing as will be described below, and the conversion table 18 as will be described below, so as to execute the conversion processing program 17.

In the present embodiment, there will be described a case where a binary code which can be executed by a certain processor is converted into a binary code which can be executed by another different processor. In this case, the certain processor is defined as an A processor, and the binary code which can be executed by the A processor is defined as an A binary code, while the processor different from the A processor is defined as a B processor, and the binary code which can be executed by the B processor is defined as a B binary code. Also, in association with these, a source program (hereinafter referred to as a source code) corresponding to the A binary code is defined as an A source code, and a source code corresponding to the B binary code is defined as a B source code. Further, a compiler which generates the A binary code by compiling the A source code is defined an A compiler, and a compiler which generates the B binary code by compiling the B source code is defined a B compiler.

FIG. 2 is a figure for explaining an example of a flow of program conversion processing according to the present embodiment.

As shown in FIG. 2, an A binary code 15a is a code generated by compiling an A source code 21 with an A compiler 22. The source code 21 is configured by an instruction group for performing predetermined processing. The A compiler 22 compiles the A source code 21 to generate an object code executable by the A processor, that is, the A binary code 15a.

The A binary code 15a is reversely compiled into a general-purpose high level language source code, for example, a C-language source code 23 by a translator 17a as the translator section. The translator 17a is a reverse compiler for reversely compiling the A binary code 15a.

The C-language source code 23 is a B source code, and is compiled by a B compiler 17b for the B processor, so that a B binary code 16a is generated from the C-language source code. The B compiler 17b compiles the C-language source code 23 to generate an object code executable by the B processor, that is, the B binary code 16a.

In the program conversion apparatus 1 according to the present embodiment, when the B binary code 16a is generated from the A binary code 15a, the C-language source code 23 as a program code for the B processor is generated by the translator 17a in the middle of the processing. When this high level language source code is generated, the translator 17a performs replacement processing in which a predetermined instruction in the A binary code 15a is extracted, and the extracted instruction is replaced with corresponding one or more instruction functions for the B processor (also referred to as an intrinsic function). Therefore, the C-language source code 23 is converted so as to include the instruction function for the B processor. Further, the translator 17a performs embedding processing in which a comment sentence, and the like, written in a predetermined form is extracted by referring to the A source code 21, and the extracted comment sentence is embedded in the generated C-language source code 23.

Conventionally, when the A binary code 15a is reversely compiled, the optimization performed at the level of the A source code 21, or at the level of the assembly code may disappear from the contents of the C-language source code 23. Further, the comment sentence, and the like, in the A source code 21 is not also reproduced in the C-language source code 23 obtained by the reverse compilation.

This will be more specifically described. There is a case where a program is optimized for the A processor at the level of the A source code 21, or at the assembly code level by a programmer. For example, the A source code 21 is optimized by using an instruction function for the A processor, or by creating a source code corresponding to a parallel degree executable in the A processor. However, even when the A source code 21 is optimized into a short code at the source code level or at the assembly code level, the short code portion may be converted into a long code by the reverse compilation.

Further, a comment sentence, and the like, in the A source code 21 is not usually included as debug information in the A binary code 15a, and hence the A comment sentence, and the like, is not included in the C-language source code 23 obtained by reversely assembling the A binary code 15a.

Thus, according to the present embodiment, it is possible to effect the processing for leaving the optimized program part, the processing for creating the comment sentence, and the like, by performing the replacement processing and the embedding processing as described above. In the following, the detail of the processing will be described.

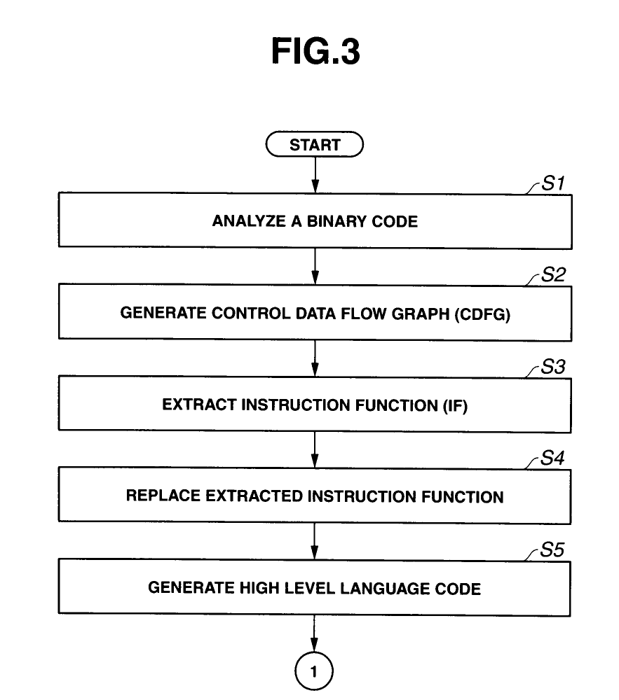

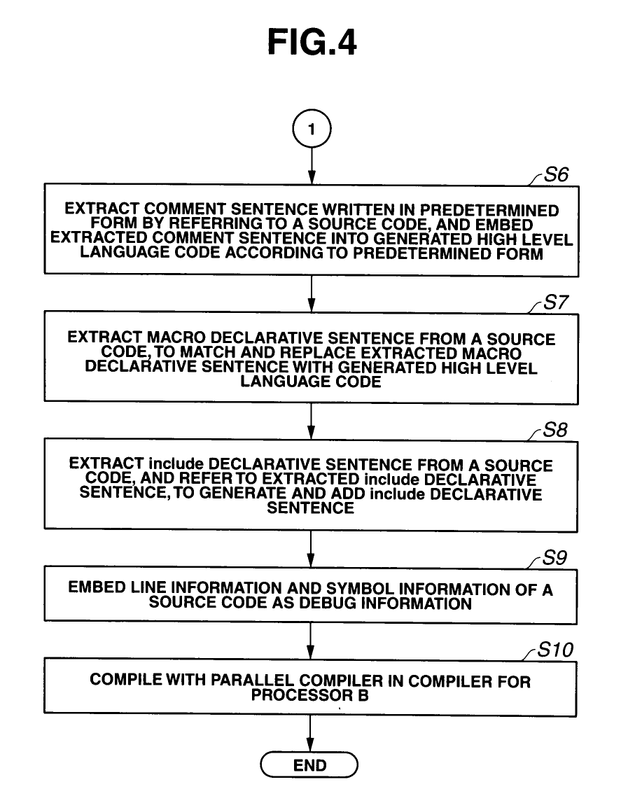

FIG. 3 and FIG. 4 are flow charts showing examples of processing flows of the conversion processing program 17 of the program conversion apparatus 1 according to the present embodiment.

The processing shown in FIG. 3 is performed by such a way that the CPU 11a in the computer main body 11 of the program conversion apparatus 1 reads and executes the conversion processing program 17 in the storage device 14.

First, the CPU 11a analyzes the conversion source A binary code 15a (step S1). Then, the CPU 11a generates a control data flow graph (CDFG) of the A binary code 15a as an internal representation from the information obtained by the analysis (step S2). Therefore, the process in step S1 configures the code analyzing section, and the process in step S2 configures a control data flow graph (CDFG) information generating section which generates the information on the control data flow graph.

When the generation of the control data flow graph about the A binary code 15a is completed, the CPU 11a extracts an instruction function (IF) from the A binary code 15a (step S3). The process in step S3 configures the instruction function extracting section which extracts a predetermined instruction function for the B processor corresponding to a predetermined instruction for the A processor.

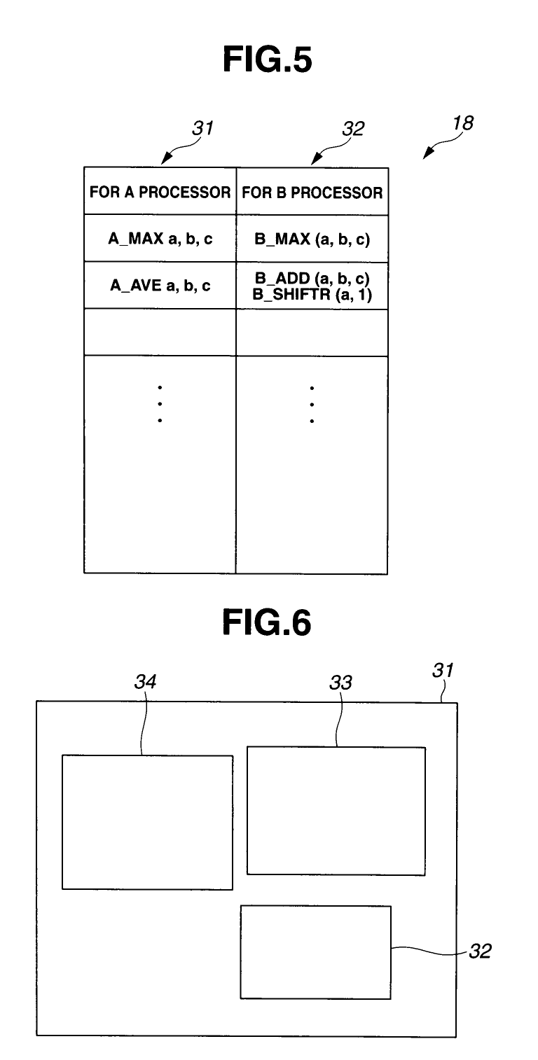

Next, the CPU 11a extracts a instruction function for the B processor by referring to the conversion table 18, and replaces the extracted instruction function for the A processor with the extracted instruction function for the B processor (step S4). This replacement is performed, for example, on a node of the control data flow graph (CDFG). FIG. 5 is a figure showing an exemplary configuration of the conversion table.

FIG. 5 shows a configuration of the conversion table 18 in which predetermined instructions included in the conversion source binary code are made to correspond to instruction functions included in the converted source code. The conversion table 18 is a correspondence table in which a plurality of predetermined instructions for the A processor are made to respectively correspond to a plurality of instruction functions (IF) for the B processor. Here, the plurality of instructions for the A processor are described in the left column 31 of the conversion table 18, and the plurality of instruction functions (IF) for the B processor are described in the right column 32 of the conversion table 18. That is, in FIG. 5, the instruction functions are stored in the right column 32 in correspondence with each of the plurality of instructions in the left column 31.

For example, it is assumed that a following maximum value detection instruction A_MAX is included in the A binary code.

A_MAX a, b, c (1)

It is assumed that the instruction (A_MAX a, b, c) is an instruction for substituting a value of larger one between b and c into a. Note that the binary code is a binary code consisting of 0 and 1, and hence the above described expression (A_MAX a, b, c) is an assembly code expression. Such an instruction function is expressed as follows, for example, by the C-language source code as a high level language which does not depend upon processors.

if(b>c) a=b;

else a=c; (2)

Even in a case where, for example, an instruction (B_MAX a, b, c) exists as an instruction for the B processor which is equivalent to the above described instruction (1), it is not generally guaranteed that the instruction (B_MAX a, b, c) is generated by the B compiler 17b from the above described instruction group (2). Usually, the B compiler 1 7b may generate, from the above described instruction group (2), a code requiring several instructions by using the comparison, branch and substitution instructions.

Thus, in the present embodiment, when it is known that a instruction function (B_MAX a, b, c) exists as a instruction function corresponding to the instruction (A_MAX a, b, c), a C-language code which is a high level language is generated as follows in correspondence with the instruction (A_MAX a, b, c).

B_MAX(a, b, c); (3)

In FIG. 5, the conversion source instructions for the A processor are made to respectively correspond to the instruction functions for the B processor. Therefore, when the instruction for the A processor extracted by the CPU 11a in step S3 exists in the left column 31 of the conversion table 18 in FIG. 5, and when the corresponding instruction function for the B processor exists in the right column 32, the CPU 11a replaces the instruction (A_MAX a, b, c) in the A binary code 15a with the instruction function B_MAX(a, b, c) in step S4.

Further, in FIG. 5, there is shown an example in which an instruction group consisting of a plurality of instruction functions (B_ADD(a, b, c) and B_SHIFR(a, 1)) is stored as a corresponding instruction for the B processor, in correspondence with an averaging instruction (A_AVE a, b, c) for the A processor.

In FIG. 5, there is shown an example in which an instruction for the A processor is made to correspond to one or more instruction functions for the B processor. However, the conversion table 18 may also be configured such that the left column 31 includes an instruction or an instruction group usually executable by the A processor, and that the right column 32 includes one or more instruction functions for the B processor corresponding to the instruction or the instruction group in the left column 31.

Then, the CPU 11a generates a C-language source code as high level language from the A binary code 15a (step S5). When generating the C-language source code, the CPU 11a generates the C-language source code so that the instruction function for the B processor extracted with reference to the conversion table 18 is included in the C-language source code. Therefore, although the A binary code 15a is optimized by the programmer by using the instruction for the A processor, the wisdom for the optimization can be eventually reflected also in the B binary code 16a for the B processor. Step S4 and step S5 configure the translator section which generates, from the A binary code 15a, the C-language source code 23 for the B processor as a program code for the B processor by rewriting a predetermined instruction for the A processor to an extracted predetermined instruction function.

As described above, the C-language source code output in step S5 is a high level language source code including the instruction function for the B processor. Therefore, when the high level language source code is compiled in step S7 as will be described below, the B binary code 16a using the instruction function for the B processor is generated, and hence is optimized similarly to the A binary code 15a which is optimized for the A processor. In the above described example, it is possible for the B compiler 17b to surely generate the B_MAX instruction.

Therefore, the C-language source code including the instruction function for the B processor is generated, to thereby improve the readability of the C-language source code. In addition, when the C-language source code is compiled with the B compiler 17b, the performance on the B processor can be expected to be maintained similarly to the performance on the A processor.

Next, the CPU 11a extracts a comment sentence written in a predetermined form from the A source code 21 by referring to the A source code 21, and embeds, that is, inserts the extracted comment sentence into the C-language source code which is generated and obtained in step S5 (step S6). The process in step S6 configures a comment sentence description form determining section.

Generally, in the conventional compile method, the comment sentence of the A source code for the A processor is not restored in the high level language source code obtained by reversely compiling the A binary code 15a, and hence the readability of the high level language source code is low. This is not only because the information of the comment sentence is not included in the ordinary debug information, but also because the conventional reverse compile technique is based on the assumption of the state where the source code is not obtained.

Further, the finally created A source code 21 written for the A processor includes an assembly code which is specialized to the architecture of the A processor and subjected to a manual modification or the like, and also includes an indicator which can be recognized only by the A compiler 22. The binary code corresponding to such modification and the like cannot be generated by the B compiler 17b.

However, even when the A source code 21 is available, a method in which the A binary code 15a is once obtained with the A compiler 22, and then is reversely compiled to the C-language source code 23 of high level language is effective. In this case, it is also desired that the comment sentence in the A source code 21 is restored.

Thus, the program conversion apparatus 1 according to the present embodiment is configured such that the comment sentence is restored in the C-language source code 23 by utilizing the A source code 21.

The comment sentence written in the predetermined form in step S6 is, for example, a comment sentence written on the basis of a description rule such as that adopted in a document automatic generation system such as Doxygen. Thus, the CPU 11a determines whether or not the comment sentence in the source code is written in the predetermined form. When determining that a certain comment sentence is written in the predetermined form, the CPU 11a embeds the comment sentence into the C-language source code generated in step S5, according to the predetermined form.

Therefore, the translator 17a includes a comment sentence description form determining section which determines, by referring to the A source code, whether or not the comment sentence in the source code for the A processor is described in the predetermined form. Then, when determining that the comment sentence in the A source code 21 is described in the predetermined form, the translator 17a embeds, according to the predetermined form, the comment sentence determined as described in the predetermined form, into the C-language source code 23 which is the source code for the B processor, so as to generate the C-language source code 23.

The processing will be described by means of specific examples.

For example, it is assumed that the following code is included in the A source code 21 which is the source code for the A processor.

$$\begin{matrix}… \\ int max ( int a , int b ) \{ return ( a > b ? a : b ) ; \} \\ / * this function returns max value * / \\ int min ( int a , int b ) \{ return ( a > b ? b : a ; \} \\ …\end{matrix} \qquad ( 4 )$$

The above described source code (4) is a source code including two function definitions and a comment sentence of one line written between two function definitions. When the source code (4) is reversely converted to the C-language source code of high level language after being compiled, it is possible to improve the readability of the source code if the part of the comment sentence can be restored together with the function max. Generally, if the debug information is included in the A binary code 15a, the function name and the variable name can be restored. However, it is impossible to automatically determine about which one of the two functions, that is, the two functions of max and min, the above described comment sentence is written.

On the other hand, the present embodiment is configured such that, when a comment sentence of the A source code 21 is written in a predetermined form for the document automatic generation system, and the like, the location of the comment sentence is determined according to the form, and thereby the comment sentence is embedded into the generated C-language source code in correspondence with the determined location and according to the predetermined form.

For example, according to the form determined beforehand in the document automatic generation system of Doxygen (see, for example, http://www.stack.nl/-dimitri/doxygen/), the above described source code (4) is written as follows.

$$\begin{matrix}… \\ / ** this function returns max value * / \\ int max ( int a , int b ) \{ return ( a > b ? a : b ) ; \} \\ int min ( int a , int b ) \{ return ( a > b ? b : a ; \} \\ …\end{matrix} \qquad ( 5 )$$

In the source code (5), the comment sentence starting with “/**” is indicated as a comment written on the basis of the form defined in the Doxygen document automatic generation system. In other words, it is explicitly shown that the comment sentence about the variable, function, and the like, in the source code (5), are written according to the form defined in the Doxygen document automatic generation system.

In the Doxygen document automatic generation system, there is a predetermined rule on which a variable and a function are respectively defined immediately after a comment sentence corresponding to each of the variable and the function. The comment sentence in the source code is written in the form according to this rule.

Therefore, the translator 17a according to the present embodiment is configured to embed the extracted comment sentence into the generated C-language source code of high level language according to the description in the predetermined form. Specifically, by utilizing the correspondence relation between a symbol such as “/**”, that is, an identifier such as a mark, and a comment sentence such as “this function returns max value”, the translator 17a is able to restore the comment sentence in the generated C-language source code of high level language, suitably in correspondence with the function relating to the comment sentence.

As a result, the comment sentence is suitably restored in the C-language source code 23, and hence the readability of the source code is improved. This enables the user to facilitate a debug, specification modification, performance tuning, and the like of the C-language source code 23.

Next, the CPU 11a extracts a macro declaration sentence in the A source code 21 by referring to the A source code 21, and performs matching to determine whether or not a text expression and the like of the extracted macro declaration is included in the C-language source code generated and obtained in step S5. When finding a matching portion, the CPU 11a embeds the macro declaration sentence and the macro expression into the C-language source code (step S7). The process of step S7 configures a macro declaration extracting section which extracts a macro declaration sentence in the A source code 21 by referring to the A source code 21. For example, in step S7, the CPU 11a generates a list of macro declaration sentences in the A source code 21, and embeds the each macro definition at the location in the C-language source code 23, which location corresponds to the each macro definition, that is, coincides with the location of the each macro declaration sentence, by referring to the macro definition included in the generated list.

Further, by referring to the A source code 21, the CPU 11a extracts an include declarative sentence from the A source code 21, and performs matching to determine whether or not a portion equivalent to the content of the extracted include file is included in the C-language source code generated and obtained in step S5. When finding the equivalent portion thereto, the CPU 11a embeds the corresponding include declarative sentence in the C-language source code (step S8). The process of step S8 configures an include declaration extracting section which extracts an include declarative sentence in the A source code 21 by referring to the A source code 21. For example, in step S8, when by referring to a content of a file including an include declarative sentence in the A source code 21, the CPU 11a finds in the C-language source code 23 a content equivalent to the content described in the file including the include declarative sentence, the CPU 11a adds the include declarative sentence to the C-language source code 23.

The processing in steps S7 and S8 will be specifically described.

For example, it is assumed that the A source code 21 which is the source code for the A processor is configured by the following two files of “myheader.h” and “main.c”.

The contents of file name of myheader.h

#define THRESHOLD 127
int binary_filter(unsigned char a){return
(a>THRESHOLD ? 255:0);}

The contents of file name of main.c

#include “myheader.h”
int main( ){
unsigned char x = 120;
return binary_filter(x);
}

In the macro declarative sentence “#define THRESHOLD 127”, it is declared that “127” is a threshold value.

In the include declarative sentence “#include “myheader.h””, it is declared that the file name of “myheader.h” is included.

Since all of the include declarative sentence and the macro declarative sentence are developed by the A compiler 22, the following one file named as “main2.c” is obtained, as a result of application of the processing in steps S1 to S5 to the binary codes corresponding to these two source codes.

The contents of file name of main2.c
int binary_filter(unsigned char a){return (a>127 ? 255:0);}
int main( ){
unsigned char x = 120;
return binary_filter(x);
}

The readability of the source code obtained as a result of the above described processing is deteriorated according to the increase in the number of include declarative sentences and the number of macro declarative sentences which are used in the A source code 21.

Thus, the translator 17a according to the present embodiment restores the macro declarative sentence and the include declarative sentence for the generated C-language source code of high level language.

Here, in step S7, by referring to the source code 21, the translator 17a extracts a macro declarative sentence such as “#define . . . ”, and adds a macro declarative sentence of the file name of myheader.h. Further, in step S7, the translator 17a replaces “127” with “THRETHHOLD” which is the macro expression of “127”, in the file name of main2.c. In this way, the macro declarative sentence and the macro expression are embedded.

Further, in step S8, the translator 17a extracts an include declarative sentence from the contents of the A source code 21 by referring to the A source code 21. Then, when adding the include declarative sentence, on the basis of the fact that a sentence of “binary filter . . . ” in the file name of main2.c is included in the referred A source code 21, the translator 17a generates and adds an include declarative sentence for including the function myheader.h which is declared to be included.

As a result, the above described one file as the program main2.c is replaced with the above described two files of main.c and myheader.h. In other words, the macro declarative sentence and the include declarative sentence which are used in the original A source code 21 are restored. Thereby, the readability of the C-language source code 23 is improved, so as to facilitate the debugging, specification modification, performance tuning, and the like.

Further, by referring to the A source code 21, the CPU 11a embeds the line number information and the symbol information of the A source code 21 into the C-language source code generated and obtained in step S5 (step S9). The process in step S9 configures a symbol and line number information embedding section which embeds the symbol information and the line number information of the A source code 21 into the C-language source code 23.

For example, it is assumed that the following codes are included in the A source code 21 which is the source code for the A processor. The numbers at the left end are provided for the sake of convenience, and are not included in the actual source code.

| The contents of file name of func.c | |
|---|---|
| 1: void function( ){ | |
| 2: if(b > c) a = b; | |
| 3: | else a = c; |
| 4: } | |

It is assumed that by applying the processing of steps S1 to S5 to the above described codes, the following result is obtained.

void f( ){
B_MAX(a, b, c);

Here, there is shown an example in which the translator 17a generates a code by utilizing a maximum value instruction B_MAX for the processor B. In this example, it is easily known by analogy that B_MAX (a, b, c) performs processing to acquire a maximum value, from the text expression of B_MAX (a, b, c). However, when an instruction function subjected to high-grade optimization, such as parallelization, is output for the processor B, it is generally difficult to grasp the contents of the processing and to perform the debugging tuning.

Thus, in step S9, the translator 17a according to the present embodiment embeds the line number information and the symbol information into the generated C-language source code of high level language, as follows.

void f( ){/** func.c, L1 function */
B_MAX(a, b, c); /** func.c, L2,3 */
}

The above described program includes information that the content of the A source code 21 corresponding to function f( ) is in the first line of “func.c”, that the symbol name as the symbol information is “function”, and that the content corresponding to B_MAX( ) is in the second and third lines of “func.c”. It is also possible for the user to directly interpret these kinds of information and to understand the processing contents by referring to the A source code 21.

Further, a parallel compiler section of the processor B suitably interprets the embedded information, and embeds the interpreted information into the binary code of the processor B in a predetermined form, as the debug information which can be used by the debugger 19. Usually, when debugging the B binary code 16a of the processor B, the debugger 19 of the processor B is able to refer to the source code 23 of the processor B. Also, the user is enabled to suitably refer to the source code 21 of the processor A by the debugger 19 of the processor B.

FIG. 6 is a figure showing an example of a debug screen displayed on a screen of the display device 13, when the B binary code is debugged by the debugger 19. On the screen 31, there are displayed the binary code display section 32 which displays the B binary code or an assembly code, a source code display section 33 which displays the C-language source code 23 corresponding to the B binary code, and a source code display section 34 which displays the A source code.

The user is able to perform the debugging of the B binary code, and the like, by referring to not only the binary code or the assembly code displayed on the binary code display section 32, or the C-language source code displayed on the source code display section 33, but also the A source code 21 displayed on the source code display section 34.

When the user selects a desired line among the codes displayed in the binary code display section 32, for example, highlight-display, or the like, of the portion of the program corresponding to the selected line is performed in the source code display sections 33 and 34.

Therefore, not only the C-language source code portion corresponding to the B binary code portion specified by the user by using the input device 12, but also the A source code portion corresponding to the B binary code portion are displayed in the source code display section 34, so that the user is able to perform the debugging of the B binary code 16a, and the like, while referring to the conversion source program.

Note that the embedding of the symbol information and the line numbers are not limited to the processing via the translator 17a. For example, it may also be configured such that when the source code for processor A multi-core or the multi-thread code is once generated by a parallel compiler of the processor A from the source code of the processor A, the symbol information and the line number information of the source code of the processor A are embedded into the source code for processor A multi-core or the multi-thread code, similarly to the above described example. This enables the original source code to be referred from a processor A parallel code debugger.

Returning to FIG. 4, when the C-language source code 23 is generated in step S5, and further when the above described processing in steps S6 to S9 is completed, the B compiler 17b then compiles the C-language source code 23, so as to generate the B binary code 16a (step S10).

Here, a parallel compiler is used as the B compiler 17b which is a compiler section. When the A processor does not correspond to the parallel processing but the B processor corresponds to the parallel processing, and when the B binary code 16a is generated from the C-language source code 23, the binary code 16a can be generated as a parallel program code corresponding to the parallel degree for the B processor by using the parallel compiler. The C-language source code 23 can be converted into a parallel program by the parallel compiler.

For example, the following loop processing is considered.

for (int i=0; i<256; i++) a[i] =b[i] +c[i]; (6)

Then, there is assumed a case where the A processor does not have a 2 parallel SIMD (Single Instruction/Multiple Data) add instruction, but the B processor has a 2 parallel SIMD add instruction, for example, B_ADD_SIMD2. At this time, the add instruction is repeated 256 times in the A processor, while the SIMD add instruction is repeated 128 (=256/2) times in the B processor. Thus, the difference in the arithmetic operation parallel degree between the A processor and the B processor can be absorbed by using a VLIW (Very Long Instruction Word)/SIMD parallel compiler as the B compiler 17b.

As described above, even when the A processor does not correspond to the parallel processing, but when the B processor corresponds to the parallel processing, the binary code 16a can be made as a code corresponding to the parallel degree of the B processor by using a parallel compiler as the B compiler 17b.

In other words, when the B processor is capable of executing higher parallel processing than the A processor, such high parallel instructions are not naturally included in the A binary code 15a, and hence the high parallel instructions of the B processor may not be fully utilized. Thus, by using a compiler corresponding to the high parallel degree of the B processor as the B compiler 17b, the B binary code 16a generated from the A binary code 15a can be made into a code corresponding to the high parallel degree of the B processor.

Further, even when a multi-thread function or a multi-core function is included in the parallel compile function of the B compiler, it is possible to obtain the same effect as described above, that is, the effect of enabling the generated code to correspond to the high parallel degree.

As described above, according to the present embodiment, when a program code is converted between different processors, it is possible to realize a program code conversion apparatus which enables ingenuity on a program, included in a conversion source binary code, to be reflected in a converted binary code.

Further, according to the present embodiment, when a high level language code is generated from a binary code which is a conversion source object code, a comment sentence, a macro declarative sentence, and the like, which are included in the source code as the origin of the conversion source binary code, are suitably restored, and thereby the user is able to facilitate the debugging, operation to cope with a specification change, performance tuning, and the like, of the high level language code.

Note that each “section” in this specification conceptually corresponds to each function of the present embodiment, but does not necessarily correspond to a specific hardware or a software routine in one-to-one relation. Therefore, the respective steps of the each procedure in the present embodiment may be executed in such a manner that the respective steps are executed on the basis of a changed execution sequence, that the plurality of steps are simultaneously executed in parallel, or that the execution sequence of the steps is changed for each time the steps of the procedure are executed, unless the execution sequence of the steps departs from the feature of the procedure.

Further, the whole or a part of the program code for performing the above described operations is recorded or stored in a portable media such as a flexible disk and a CD-ROM, and in a recording medium such as a storage device of a hard disk or the like. The program code can be provided as a computer program product which is read by a computer, and the whole or a part of which is executed by the computer. Alternatively, the whole or a part of the program code can be circulated or provided via a communication network. The user is able to easily realize a program code conversion apparatus according to the present invention by downloading the program code via the communication network and installing the program code in a computer, or by installing the program code in a computer from the recording medium.

The present invention is not limited to the above described embodiment, and various modification, changes or the like, are possible within the scope and spirit of the invention.

What is claimed is:

1. A program code conversion apparatus configured to convert a first binary code executable in a first processor into a program code for a second processor, comprising:
a code analyzing section configured to analyze the first binary code;
a instruction function extracting section configured to extract predetermined one or more instruction functions for the second processor which correspond to predetermined one or more instructions for the first processor obtained by the analysis performed by the code analyzing section; and
a translator section configured to generate a source code for the second processor as a program code for the second processor from the first binary code, by rewriting the predetermined one or more predetermined instructions for the first processor to the predetermined one or more instruction functions extracted by the instruction function extracting section.

2. The program code conversion apparatus according to claim 1, further comprising:
a correspondence table in which the predetermined one or more instructions for the first processor and the predetermined one or more instruction functions for the second processor are made to correspond to each other,
wherein the instruction function extracting section extracts, by referring to the correspondence table, the predetermined one or more instruction functions for the second processor which correspond to the predetermined one or more instructions for the first processor obtained by the analysis.

3. The program code conversion apparatus according to claim 1, further comprising:
a control data flow graph information generating section configured to generate control data flow graph information on the basis of information obtained by the analysis performed by the code analyzing section,
wherein the translator section performs the rewriting on a node in the generated control data flow graph information.

4. The program code conversion apparatus according to claim 1, further comprising:
a comment sentence description form determining section configured, by referring to a source code for the first processor corresponding to the first binary code, to determine whether or not a comment sentence in the source code for the first processor is described in a predetermined form,
wherein when the comment sentence description form determining section determines that the comment sentence in the source code for the first processor is described in the predetermined form, the translator section generates a source code for the second processor by embedding the comment sentence determined as described in the predetermined form into the source code for the second processor.

5. The program code conversion apparatus according to claim 1, further comprising:
a macro declaration extracting section configured, by referring to the source code for the first processor corresponding to the first binary code, to extract a macro declarative sentence in the source code for the first processor,
wherein the translator section performs, by referring to the macro declarative sentence extracted by the macro declaration extracting section, matching between the extracted macro declarative sentence and the source code for the second processor, and generates the source code for the second processor by embedding the macro declarative sentence and macro expression in the source code for the second processor.

6. The program code conversion apparatus according to claim 1, further comprising:
an include declaration extracting section configured, by referring to a source code for the first processor corresponding to the first binary code, to extract an include declarative sentence in the source code for the first processor,
wherein the translator section performs, by referring to the include declarative sentence extracted by the include declaration extracting section, matching between the extracted include declarative sentence and the source code for the second processor, and adds the include declarative sentence to the source code for the second processor.

7. The program code conversion apparatus according to claim 1, further comprising a parallel compiler section configured to generate a second binary code of a parallel program executable in the second processor as a program code for the second processor, from the source code for the second processor generated by the translator section.

8. The program code conversion apparatus according to claim 7, further comprising:
a symbol and line number information embedding section configured, by referring to a source code for the first processor corresponding to the first binary code, to embed symbol information and line number information which correspond to the source code for the first processor, into the source code for the second processor,
wherein the parallel compiler section embeds debug information available for a debugger for the second processor into the binary code for the second processor on the basis of the symbol information and the line number information which are embedded.

9. A program code conversion method for converting a first binary code executable in a first processor into a program code for a second processor by a computer including a code analyzing section, a instruction function extracting section, and a translator section, the program code conversion method comprising:
analyzing the first binary code by the code analyzing section;
extracting, by the instruction function extracting section, predetermined one or more instruction functions for the second processor which correspond to predetermined one or more instructions for the first processor obtained by the analysis performed by the code analyzing section; and
generating, by the translator section, a source code for the second processor as a program code for the second processor from the first binary code, by rewriting the predetermined one or more predetermined instructions for the first processor to the predetermined one or more instruction functions extracted by the instruction function extracting section.

10. The program code conversion method according to claim 9, further comprising:
extracting, by referring to a correspondence table in which the predetermined one or more instructions for the first processor and the predetermined one or more instruction functions for the second processor are made to correspond to each other, the predetermined one or more instruction functions for the second processor which correspond to the predetermined one or more instructions for the first processor obtained by the analysis.

11. The program code conversion method according to claim 9, further comprising:
generating control data flow graph information on the basis of information obtained by the analysis performed by the code analyzing section; and
performing the rewriting on a node in the generated control data flow graph information.

12. The program code conversion method according to claim 9, further comprising:
determining, by referring to a source code for the first processor corresponding to the first binary code, whether or not a comment sentence in the source code for the first processor is described in a predetermined form; and
generating, when it is determined that the comment sentence in the source code for the first processor is described in the predetermined form, a source code for the second processor by embedding the comment sentence determined as described in the predetermined form into the source code for the second processor.

13. The program code conversion method according to claim 9, further comprising:
extracting, by referring to a source code for the first processor corresponding to the first binary code, a macro declarative sentence in the source code for the first processor; and
performing, by referring to the extracted macro declarative sentence, matching between the extracted macro declarative sentence and the source code for the second processor, and generating the source code for the second processor by embedding the macro declarative sentence and macro expression in the source code for the second processor.

14. The program code conversion method according to claim 9, further comprising:
extracting, by referring to a source code for the first processor corresponding to the first binary code, an include declarative sentence in the source code for the first processor; and
performing, by referring to the extracted include declarative sentence, matching between the extracted include declarative sentence and the source code for the second processor, and adding the include declarative sentence to the source code for the second processor.

15. The program code conversion method according to claim 9, further comprising:
generating a second binary code of a parallel program executable in the second processor as a program code for the second processor, from the source code for the second processor generated by the translator section.

16. The program code conversion method according to claim 15, further comprising:
embedding, by referring to a source code for the first processor corresponding to the first binary code, symbol information and line number information which correspond to the source code for the first processor, into the source code for the second processor; and
embedding debug information available for a debugger for the second processor into the binary code for the second processor on the basis of the symbol information and the line number information which are embedded.

17. A program recording medium for enabling execution of a program code conversion method in which a first binary code executable in a first processor is converted into a program code for a second processor by a computer including a code analyzing section, a instruction function extracting section, and a translator section, the program recording medium comprising:
a first code section configured to make the code analyzing section analyze the first binary code;
a second code section configured to make the instruction function extracting section extract predetermined one or more instruction functions for the second processor which correspond to predetermined one or more instructions for the first processor obtained by the analysis performed by the code analyzing section; and
a third code section configured to make the translator section generate a source code for the second processor as a program code for the second processor from the first binary code, by rewriting the predetermined one or more predetermined instructions for the first processor to the predetermined one or more instruction functions extracted by the instruction function extracting section.

18. A program code conversion apparatus configured to convert a first binary code executable in a first processor into a program code for a second processor, comprising:
a comment sentence description form determining section configured, by referring to a source code for the first processor corresponding to the first binary code, to determine whether or not a comment sentence in the source code for the first processor is described in a predetermined form; and
a translator section configured, when the comment sentence description form determining section determines that the comment sentence in the source code for the first processor is described in the predetermined form, to generate a source code for the second processor by embedding the comment sentence determined as described in the predetermined form into the source code for the second processor according to the predetermined form.

19. The program code conversion apparatus according to claim 18, further comprising:
a macro declaration extracting section configured, by referring to the source code for the first processor corresponding to the first binary code, to extract a macro declarative sentence in the source code for the first processor,
wherein the translator section performs, by referring to the macro declarative sentence extracted by the macro declaration extracting section, matching between the extracted macro declarative sentence and the source code for the second processor, and generates the source code for the second processor by embedding the macro declarative sentence and macro expression into the source code for the second processor.

20. The program code conversion apparatus according to claim 18, further comprising:
an include declaration extracting section configured, by referring to the source code for the first processor corresponding to the first binary code, to extract an include declarative sentence in the source code for the first processor,
wherein the translator section performs, by referring to the include declarative sentence extracted by the include declaration extracting section, matching between the extracted include declarative sentence and the source code for the second processor, and adds the include declarative sentence to the source code for the second processor.
